(19) United States
(12) Patent Application Publication
(10) Pub. No.: US 2002/0032842 A1
(43) Pub. Date: Mar. 14, 2002

(54) Data acquisition apparatus and memory controller

(76) Inventors: Shigeo Kawauchi, Tokyo (JP); Kazuhiro Tsujikawa, Tokyo (JP)

Correspondence Address: DELLETT AND WALTERS, 310 S.W. FOURTH AVENUE, SUITE 1101, PORTLAND, OR, 97204, US

(21) Appl. No.: 09/943,745

(22) Filed: Aug. 30, 2001

Related U.S. Application Data
(62) Division of application No. 09/191,793, filed on Nov. 13, 1998.

(30) Foreign Application Priority Data
Nov. 19, 1997 (JP) 9-335037
Nov. 11, 1998 (JP) 10-336564

(51) Int. Cl. G06F 13/00

(52) U.S. Cl. 711/147

(57) ABSTRACT

The present invention discloses the data acquisition apparatus for acquiring the data sent and/or received via lines to be sequentially stored in a storing means and the memory controller. In such an arrangement, a data acquisition processing unit acquires the data sent and/or received via the lines, and transfers the data to the storing means for sequentially storing the acquired data. Moreover, the memory controller used for the above data transfer operation and other purposes selects an access destination for a data read/write request sent from a first processor in accordance with the access information for the data read/write permission for first and second memories.

### BACKGROUND OF THE INVENTION

The present invention relates to a data acquisition apparatus for acquiring various signals sent and/or received via lines such as ISDN to be displayed and memory controller.

Recently, with the progress of the advanced information society, the digital network has been developed. In particular, the Internet connection through the ISDN lines has been rapidly popularized, and Internet service providers increasingly possess their private lines. A data acquisition apparatus which is called a protocol analyzer monitors the signals sent and/or received via such various lines and performs fault detection. As the above-described ISDN lines and the like are popularized, high speed of transferring information is of necessity and the fault detection is also required in a plurality of lines. Therefore, it is expected to realize a high speed data acquisition apparatus and the processing through a plurality of channels.

FIG. 13 is a diagram showing an arrangement of a conventional data acquisition apparatus. As illustrated in FIG. 13, the data acquisition apparatus comprises one or a plurality of monitor boards 110 formed to correspond to physical lines, and a host processing unit 120 for storing various data acquired by the respective monitor boards 110 and for displaying the content thereof.

The monitor board 110 includes a signal processing unit 112, a monitor processing unit 114, a monitor side microprocessor (monitor side MPU) 116, and a memory 118. The monitor board 110 acquires and sequentially saves data sent and/or received via lines in the memory 118.

The host processing unit 120 includes a host side MPU 122, a monitor display 124, and a hard disk drive 126. The acquired data is read from the memory 118 in each monitor board 110 by the control of the host side MPU 122. The acquired data that have been read out are transferred to the monitor display 124 or the hard disk drive 126. The monitor display 124 displays the thus transferred data in a predetermined display format. The hard disk drive 126 is designed to record the acquired data for a long time, and to save the acquired data that has been sequentially transferred by the control of the host side MPU 122.

The use of the above-described data acquisition apparatus enables data having various systems sent and/or received via a plurality of lines to be simultaneously acquired to display the content thereof. A long-time recording for the acquired data can be also attained.

Incidentally, in the above-described conventional data acquisition apparatus, the data acquired by the plurality of monitor boards 110 are transferred to the monitor display 124 and the hard disk drive 126 by the control of the host side MPU 122 in the host processing unit 120. With such an arrangement, the data transfer rate is limited, resulting from the processing capability of the host side MPU 122 and the hardware configuration. Thus, such a problem has been arisen that the number of lines to be a candidate for the long-time recording has limitation. Considering the ISDN lines including B channels each having the communication capacity of 64 kbps, if the data sent and/or received via one of the B channels are recorded for a long time, the host side MPU 122 must read out the data from the memory 118 at the rate of 64 kbps, and transfer the data to the hard disk drive 126 at the same rate. Accordingly, the apparatus may be loaded greatly even when the data via one of the B channels are recorded for a long time. For this reason, the number of lines used for a long-time recording is limited up to, for example, two lines. Therefore, there exist the other lines used for the monitor display, but not used for the long-time recording.

Further, as previously described, in the conventional apparatus, the monitor display for the data is performed in conjunction with the long-time recording therefor. When the data is attempted to be recorded for a long time, the data transfer operation to the hard disk drive 126 must be performed with priority. Therefore, the host side MPU 122 for analyzing the acquired data has so large burden for process that there occurs inconvenience that in some instances the screen for the monitor display is changed with delay in accordance with the processing capability.

Moreover, in the case of the above-described conventional data acquisition apparatus, when the host processing unit 120 performs various types of processing such as storing of data in the hard disk drive 126 and predetermined monitor display by the monitor display 124 or analysis of various data values, the memory 118 is frequently used and thereby, data cannot be efficiently transferred because the data necessary for these types of processing is transferred through the memory 118 in the monitor board 110. Particularly, to increase the number of lines used for long-time recording, the frequency of the access to the memory 118 increases because data is transferred to the hard disk drive 126 and thus, the above access easily competes with the access to the memory 118 for other types of processing. Therefore, a memory controller capable of efficiently accessing a memory is desired.

To overcome such an inconvenience as described above, the present invention has been made, and an object of the present invention is to provide a data acquisition apparatus capable of increasing the lines to be a candidate for the long-time recording and of reducing the processing load on the displaying side.

Moreover, it is another object of the present invention to provide a memory controller capable of efficiently accessing a memory.

### SUMMARY OF THE INVENTION

In one preferred embodiment of the present invention, the data acquisition apparatus has an arrangement such that since a data acquisition unit for acquiring the data sent and/or received via lines performs the transfer operation of the data to a storing means, a data display processing unit for displaying the acquired data is not required to transfer the data to the storing means. For this reason, the load can be reduced for the processing. In particular, a hard disk drive is preferably used for the storing means. In general, the hard disk drive has a large storage capacity, and a high reading and/or writing speed for the data, thereby being suitable for recording the data sent and/or received via the lines for a long time.

The above-described data acquisition processing unit comprises a data extracting means for extracting the data sent and/or received via the lines, a fist memory used for the data transfer to the data display processing unit, and a second memory used for the data transfer to the storing means. Since the second memory is separately prepared for the data transfer to the storing means, the data transfer to the data display processing unit and the data recording in the storing means can be simultaneously carried out. Therefore, the recording operation of the data in the storing means may not cancel the display processing of the acquired data, or alternatively the display processing of the data conversely may not cancel the recording operation of the data in the storing means. Consequently, the recording operation of the data in the storing means can be realized at high speed and efficiently.

Further, the data acquisition processing unit preferably comprises a first processor for instructing to write the data extracted by the data extracting means into the first and second memories, a memory controller for writing the data into the first and second memories according to a single write instruction made by the first processor, and a second processor for storing the data read out from the second memory to the storing means. Since with use of the memory controller, a single write instruction enables the data to be written into the two memories, the processing load for the first processor and time periods required to write the data can be reduced, to thereby maintain a sufficient time to acquire the data, enabling a correspondence to high speed lines.

Particularly, it is preferable to write data in both first and second memories by a memory controller when write of data is designated by a first processor by previously setting a common address to the storage regions of the first and second memories. Or, it is preferable to read data from one of first and second memories by a memory controller and write the data in the same address of the other memory when read and write of data are designated by a first processor. Because the first processor specifies one address to designate write or read of data, it is easy to control addresses and simplify various types of processing.

Still further, when the data acquisition apparatus of the present invention includes a plurality of the data acquisition processing units, each of the data acquisition processing units preferably connects to the storing means in an individual basis. In this case, while the data acquisition processing unit transfers the data to the storing means, even if the lines to be a candidate for acquisition of the data increase, the data acquisition processing unit corresponding to the respective lines can record the data in the storing means. Accordingly, there is no limitation to the number of lines used for recording the data in the storing means, and the lines to be a candidate for the long-time recording can be increased.

Furthermore, a memory controller of the present invention is provided with an access selecting section for selecting a memory to be actually accessed in accordance with the access information for read/write permission of data for two connected memories (first and second memories). Therefore, it is possible to set the access state from a first processor to each memory according to necessity by changing the contents of the access information and thus, it is possible to efficiently access each memory. Moreover, by using a first bus switching section for connecting the first processor with the first memory in accordance with a selection result by the access selecting section and a second bus switching section for connecting the first processor with the second memory, it is possible to switch memories to be used in accordance with the above access information. Therefore, it is possible to properly select a case of accessing the first and second memories and a case of accessing only one of the first and second memories.

Particularly, when it is permitted to write data in the first and second memories in accordance with the access information, by designating data write with the first processor, it is possible to write data in the first and second memories through one-time write designation. Moreover, when it is permitted to read data from one of the first and second memories and it is permitted to write data in one of the first and second memories, by designating read and write of data with the first processor, it is possible to perform the data transfer for writing the data read out of one memory in the other memory. In any case, by previously setting a common address to the storage regions of the first and second memories, it is possible to efficiently access each memory by using a small address space because the first processor can perform the above operations only by designating one address when simultaneously writing data or transferring data.

Moreover, by dividing the storage region of the first or second memory into a plurality of regions and setting the above access information to each divided storage region, it is possible to read or write data from or in the first and second memories by using an access method different for each divided region and moreover, it is possible to efficiently access each memory.

### BRIEF DESCRIPTION OF THE DRAWINGS

FIG. 1 is a diagram showing an arrangement of a data acquisition apparatus according to an embodiment of the present invention;

FIG. 2 is an explanatory diagram showing an operational procedure of the data acquisition apparatus in the case where the normal monitor operation is carried out;

FIG. 3 is an explanatory diagram showing an operational procedure of the data acquisition apparatus in the case where the long-time recording operation is carried out;

FIG. 4 is an explanatory diagram showing an operational procedure of the data acquisition apparatus in the case where the data recorded for a long time are read out to be displayed;

FIG. 5 is an explanatory diagram showing another operational procedure of the data acquisition apparatus in the case where the data recorded for a long time are read out to be displayed;

FIG. 6 is a diagram showing the detailed structure of a memory controller;

FIG. 7 is a diagram showing the relation between contents of a register in an access selecting section and various access permissions to two memories;

FIG. 8 is a diagram showing another example of the set contents of a register in an access selecting section;

FIG. 9 is a diagram showing still another example of the set contents of a register in an access selecting section;

FIG. 10 is a diagram showing still another example of the set contents of a register in an access selecting section;

FIG. 11 is a diagram showing various storage regions when dividing a memory into four regions in accordance with the number of monitor processing units;

FIG. 12 is a diagram showing four registers corresponding to four divided regions in a memory; and

FIG. 13 is a diagram showing an arrangement of a conventional data acquisition apparatus.

### DESCRIPTION OF THE PREFERRED EMBODIMENT

A data acquisition apparatus according to an embodiment to which the present invention is applied has a feature to provide a hard disk drive used as a storing means on each of monitor boards and to effect an operation of monitoring corresponding lines for a long time. Detailed description will now be made of the data acquisition apparatus according to one embodiment to which the present invention is applied with reference to the accompanying drawings.

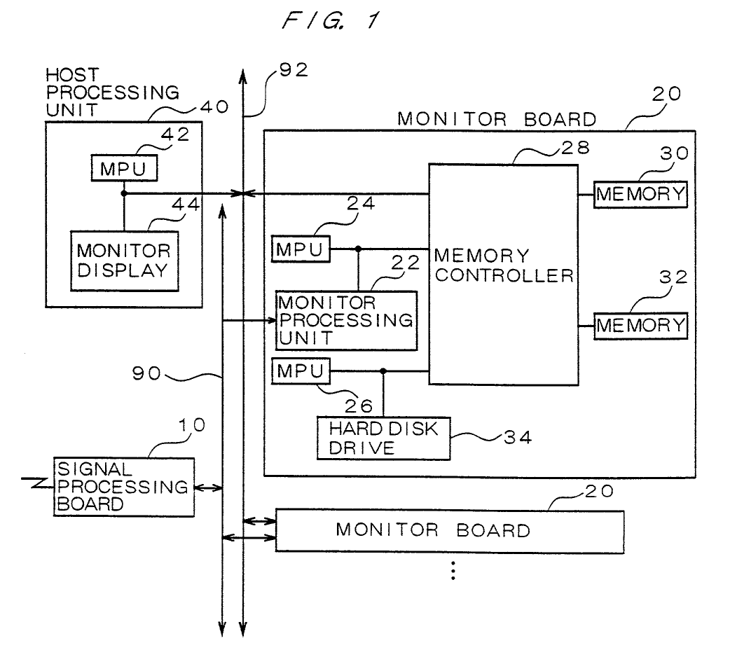

FIG. 1 is a diagram showing an arrangement of the data acquisition apparatus of the embodiment of the present invention. In FIG. 1, the data acquisition apparatus comprises a signal processing board 10, one or a plurality of monitor boards 20, and a host processing unit 40.

The signal processing board 10 is connected to one or a plurality of physical lines, and establishes the synchronization to the signals received via these lines. With respect to the data having a frame configuration, frames of the data are extracted, while bit strings of the data that have no frame configuration are extracted. The extracted data in this way are outputted to a measurement data acquiring bus 90.

The lines connected to the signal processing board 10 include private lines and serial lines such as RS232C other than switched lines such as ISDN lines and packet lines, and the signal processing board 10 is used associated with the type of the line. For example, the signal processing board 10 involved in the data acquisition apparatus according to the embodiment of the present invention is connected to a plurality of ISDN lines. With respect to the signals inputted through these connected ISDN lines, the bit synchronization is established and subsequently the frame synchronization of a layer 1 is established to isolate the data of the B channel.

The monitor board 20 is intended to extract predetermined data to be a candidate for acquisition among various data outputted to the measurement data acquiring bus 90 from the signal processing board 10 to perform the acquisition processing of the data. Also, the monitor board 20 sequentially saves the acquired data depending upon necessity to be recorded for a long time.

The monitor board 20 comprises a monitor processing unit 22, two MPUs 24 and 26, a memory controller 28, two memories 30 and 32, and a hard disk drive 34.

The monitor processing unit 22 extracts only data that meets with the acquisition requirement among the multiplexed data outputted onto the measurement data acquiring bus 90. For example, in the case where the data of one of the B channels involved in a primary interface of the ISDN lines are acquired, the data involved in an HDLC frame are extracted.

The HDLC frame comprises a flag sequence F, an address field A, a control field C, an information field I, a frame check sequence FCS, and a flag sequence F in the order named. In this case, a flag pattern (“01111110”) of 7EH (H indicates one given in hexadecimal) is assigned to the top and last flag sequences Fs. When “1”s are continuously present for 6 bits or more in the actual data contained in the information field I, “0” is forcibly inserted by the sender of the data. The monitor processing unit 22 then handles to delete the “0” inserted by the sender. The monitor processing unit 22 further serves to confirm whether the address field A, the control field C, and the information field I of the HDLC frame could have been received without failure in accordance with the frame check sequence FCS.

One of the MPUs 24 controls to write the data extracted by the monitor processing unit 22 into the two memories 30 and 32, whereas the other MPU 26 controls to read out the data written into the memory 32 and transfer the read data to the hard disk drive 34.

The memory controller 28 is designed to control the read and write operations of the data from and into the two memories 30 and 32. The memory controller 28 also controls to simultaneously or alternatively write the data into the two memories 30 and 32 in responsive to the instructions of MPU 24, MPU 26 and the like, or controls to read out the data saved in the memories 30 and 32. The simultaneous write control operation for the data will be described later.

The two memories 30 and 32 works as dynamic RAM (DRAM). The memory 30 is mainly used to transfer the data between the monitor board 20 and the host processing unit 40, while the memory 32 is used to read and write the data from and to the hard disk drive 34. The hard disk drive 34 in turn stores the data read out from the memory 32 by the control of the MPU 26. For example, areas each having the capacity of several ten to several hundred megabytes per line are assigned for a long-time recording, the data transferred by the MPU 26 are saved cyclically in these areas.

The host processing unit 40 comprises an MPU 42 and a monitor display 44 for receiving the data acquired using the monitor board 20 to be converted into a given display format and displaying the result. The MPU 42 is connected to the memory controller 28 in the monitor board 20 via the host side MPU bus 92, and can read and write the data from and to the memory 30. The MPU 42 further reads out the acquired data saved in the memory 30, converts the read out acquired data into a display format designated by a user to generate a monitor image, and displays the image on the screen of the monitor display 44.

In the foregoing description, the monitor board 20 corresponds to a data acquisition processing unit, the monitor processing unit 22 corresponds to a data extracting means, the MPU 24 corresponds to a first processor, the MPU 26 corresponds to a second processor, the memory controller 28 corresponds to a memory control means, the memory 30 corresponds to a first memory, the memory 32 corresponds to a second memory, the hard disk drive 34 corresponds to a storing means, and the host processing unit 40 corresponds to a data display processing means.

According to the embodiment of the present invention, the data acquisition apparatus has such an arrangement, the operation of which will now be described. By way of example, description will be given of each of the following cases: 1) the operation in which the data acquired by the monitor processing unit 22 are sent to the host processing unit 40, without being stored in the hard disk drive 34, to display the content thereof (a normal monitor operation); 2) the operation in which the data acquired by the monitor processing unit 22 are sent to the hard disk drive 34 to be recorded for a long time (a long-time recording operation); and 3) the operation in which the acquired data recorded in the hard disk drive 34 are read out, and the read out data are sent to the host processing unit 40 to display the content thereof (a long-time recording/reproduction operation).

1) A normal monitor operation

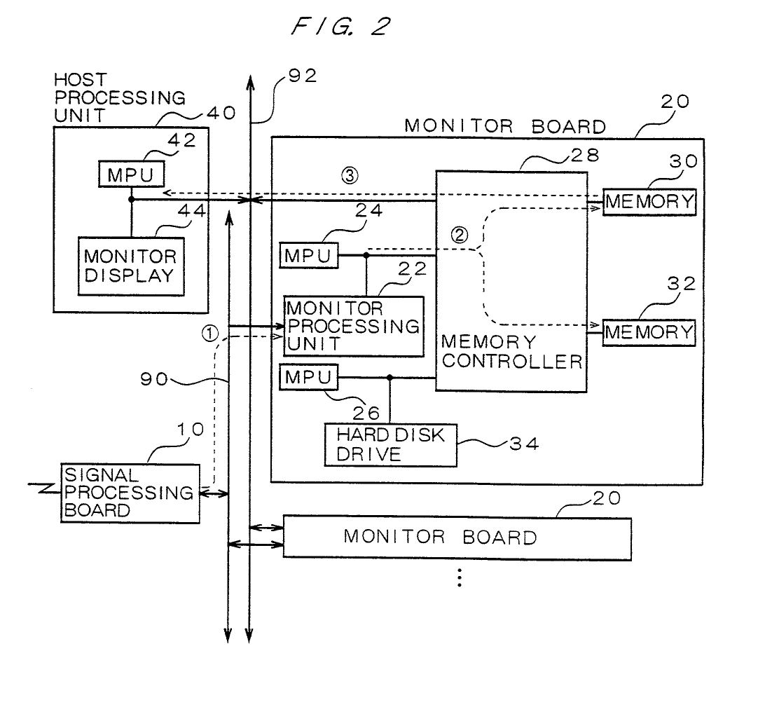

FIG. 2 is a diagram explaining the operational procedure in case of the normal monitor operation. In FIG. 2, the arrowed dotted lines indicate the transfer directions of the data, and the assigned numerals \mathring{1}, \mathring{2}, etc. indicate the order of transfer. The respective steps of the normal monitor operation will be explained according to the order of transferring the data as below.

\mathring{1} The monitor processing unit 22 isolates and extracts the data to be a candidate for acquisition among the multiplexed data on the measurement data acquiring bus 90. For example, the monitor processing unit 22 extracts the data contained in the HDLC frames of the B channels via the ISDN lines. Extracting the data in this way, the monitor processing unit 22 informs the MPU 24 of the data extracting.

\mathring{2} The MPU 24 sends to the memory controller 28 an instruction to write the data acquired by the monitor processing unit 22 into the two memories 30 and 32. The acquired data is then written into the memories 30 and 32 by the control of the memory controller 28.

Specifically, the MPU 24 sends to the memory controller 28 the write address and the acquired data, and designates the simultaneous write mode. Once the simultaneous write mode is designated, the memory controller 28 controls to write the acquired data into the designation address of the memory 30, and concurrently to write the same acquired data into the same designation address of the memory 32. As a result, by designating the simultaneous write mode, the acquired data can be simultaneously written into the same addresses of the memories 30 and 32 once a single write operation is performed by the MPU 22.

\mathring{3} The MPU 42 in the host processing unit 40 monitors the memory 30, and when the acquired data are written into the memory 30, sends to the memory controller 28 an instruction to read out the written-in acquired data. Then, the written acquired data are read out from the memory 30 by the control of the memory controller 28. The MPU 42 is thereafter converts the read out acquired data into the display format designated by a user to display the converted data onto the monitor display 44.

In the case of the above monitor operation, the MPU 24 transmits a write address and acquired data to the memory controller 28. However, it is also possible that the monitor processing unit 22 serves as a bus master to designate an address. In this case, a designation for effectuating the DMA (Direct Memory Access) by the monitor processing unit 22 and various set data values necessary for transfer of a write address or the like serving as a data transfer destination are sent from the MPU 24 to the monitor processing unit 22 before extracting data by the monitor processing unit 22 and the MPU 24 designates the simultaneous write mode to the memory controller 28.

When the above preparation is completed and the data to be acquired is extracted by the monitor processing unit 22, the gist is communicated from the monitor processing unit 22 to the MPU 24 and thereafter, a DMA transfer request is sent to the MPU 24. The MPU 24 delivers the right of use of data buses and address buses present between the MPU 24 and the memory controller 28 to the monitor processing unit 22 in accordance with the DMA transfer request sent from the monitor processing unit 22. Thereafter, the monitor processing unit 22 becoming a bus master sends a write address and acquired data to the memory controller 28. Because the simultaneous write mode is already designated, the memory controller 28 writes the acquired data in the designated address of the memory 30 and performs the control for writing the same acquired data in the same designated address of the memory 32. When the above DMA transfer is completed, the monitor processing unit 22 sends the notice showing the gist to the MPU 24 and completes the operation as a bus master. In the case of the above example, the monitor processing unit 22 corresponds to both the data extraction means and the first processor.

2) A long-time recording operation

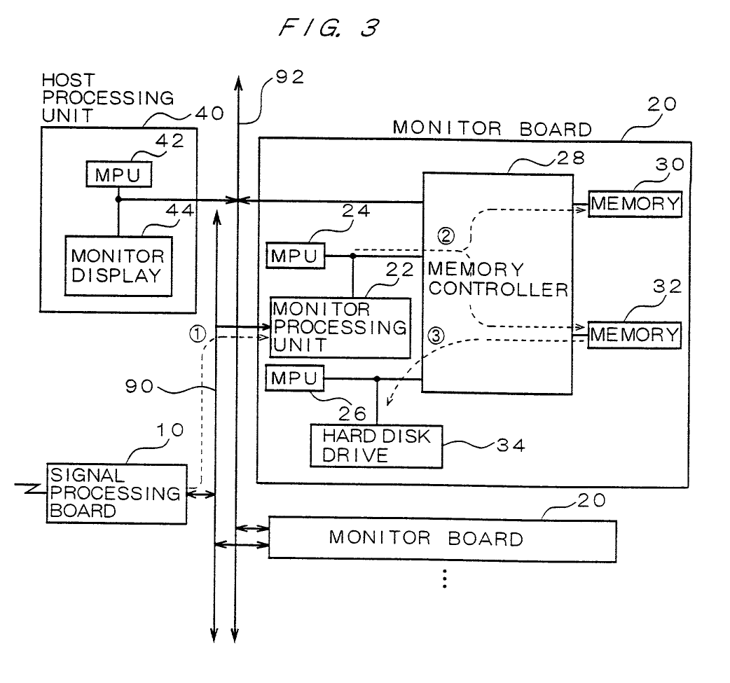

FIG. 3 is a diagram explaining the operational procedure in case of the long-time recording of the acquired data by the monitor board 20.

\mathring{1}, \mathring{2} The same processes are given to the process of extracting the acquired data by the monitor processing unit 22 and the process of simultaneously writing the data into the two memories 30 and 32 as explained at (1) the normal monitor operation. Thus, the description will be omitted. Description will now be given of the operation after writing the acquired data into the memory 32.

\mathring{3} When the acquired data saved in the memory 32 reaches a predetermined amount, the MPU 26 sends to the memory controller 28 an instruction to read out the acquired data saved in the memory 32, and the acquired data are read out from the memory 32 by the control of the memory controller 28. The MPU 26 sends the read out acquired data to the hard disk drive 34, saving in turn the data into the long-time recording areas set in the hard disk drive 34.

Moreover, when, as described previously, the MPU 26 reads out the acquired data from the memory 32 and writes the acquired data into the hard disk drive 34, the MPU 42 in the host processing unit 40 concurrently reads out the acquired data from the memory 30 in a similar manner to the normal monitor operation. Subsequently, the certain monitor display operation is carried out by the monitor display 44.

3) A long-time recording/reproduction operation (No. 1)

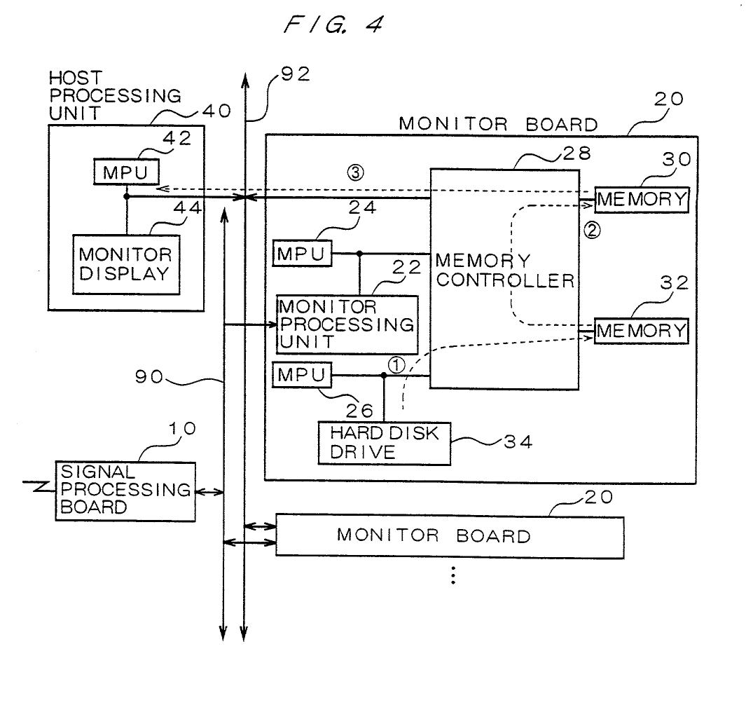

FIG. 4 is a diagram explaining the operational procedure in case of the long-time recording/reproduction operation, in which the acquired data saved in the hard disk drive 34 are read out to display the content thereof.

\mathring{1} When a user instructs to readout the acquired data saved in the hard disk drive 34 to display the read out data in a given format, the MPU 26 in turn reads out the acquired data saved in the hard disk drive 34, and sends to the memory controller 28 an instruction to write the read out acquired data into only the memory 32. Accordingly, the acquired data are simultaneously written into only the memory 32 by the control of the memory controller 28.

\mathring{2} The MPU 24 monitors the memory 32, and when the acquired data are written into the memory 32, reads out the written acquired data, writes the read out acquired data into the other memory 30, and transfers the acquired data from the memory 32 to the memory 30.

\mathring{3} The MPU 42 in the host processing unit 40 sends to the memory controller 28 an instruction to read out the acquired data written into the memory 30. The acquired data are read out from the memory 30 by the control of the memory controller 28. Subsequently, the MPU 42 converts the read out acquired data into the display format designated by a user to display the converted data onto the monitor display 44.

4) A long-time recording/reproduction operation (No. 2)

FIG. 5 is a diagram explaining a modified example of the operational procedure in case of the long-time recording/reproduction operation, in which the acquired data saved in the hard disk drive 34 are read out to display the content thereof.

\mathring{1} When a user instructs to read out the acquired data saved in the hard disk drive 34 to display the read out data in a given format, the MPU 26 in turn reads out the acquired data saved in the hard disk drive 34, and sends to the memory controller 28 an instruction to write the read out acquired data into the two memories 30 and 32. Accordingly, the acquired data are simultaneously written into the memories 30 and 32 by the control of the memory controller 28.

As with the previous description in the normal monitor operation (1), the simultaneous write operation of the acquired data is carried out such that the MPU 26 sends the write address and the acquired data to the memory controller 28 and the simultaneous write mode is designated. \mathring{2} The MPU 42 in the host processing unit 40 sends to the memory controller 28 an instruction to read out the acquired data written in the memory 30. The acquired data are then read out from the memory 30 by the control of the memory controller 28. The MPU 42 subsequently converts the read out acquired data into the display format designated by a user to display the converted data onto the monitor display 44.

As explained for the above 1) Normal monitor operation to 4) Long-time recording/reproducing (No. 2), according to the embodiment of the present invention, the data acquisition apparatus includes the hard disk drive 34 on the monitor board 20, in which the MPU 26 different from the MPU 24 that controls to write the acquired data into the memories 30 and 32 saves the acquired data in the hard disk drive 34. With such an arrangement, since the acquired data can be recorded for a long time independently from the display operation by means of the host processing unit 40, the processing load may be reduced for the host processing unit 40. Further, if a plurality of monitor boards 20 are used, the above-described long-time recording operation is carried out for each monitor board 20. As a result, in the case where the lines to be a candidate for acquisition of the data are increased, adaptation thereto may be facilitated.

In particular, since the monitor board 20 is provided with the two memories 30 and 32 thereon, the saving operation of the acquired data in the hard disk drive 34 and the transfer operation of the acquired data to the host processing unit 40 may be simultaneously carried out. For this reason, one operation may not cancel the other operation, so that a long-time recording operation can be realized at high speed and efficiently.

Further, since the memory controller 28 is available, a single write instruction by the MPU 24 enables the acquired data to be simultaneously written into the two memories 30 and 32. Therefore, the processing load and time periods required for the MPU 24 to write the acquired data can be reduced, to thereby maintain a sufficient time to acquire the data, enabling a correspondence to high speed lines or the like.

Detailed structure and operations of memory controller

Then, a specific structure of the memory controller 28 for controlling the simultaneous write operation in two memories 30 and 32 of the data acquisition apparatus of this embodiment described above is described below. For example, it is assumed for the MPU 24 to read or write data from or in each of the two memories 30 and 32, for the MPU 26 to read or write data from or in only the memory 32, and for the MPU 42 to read or write data from or in only the memory 30.

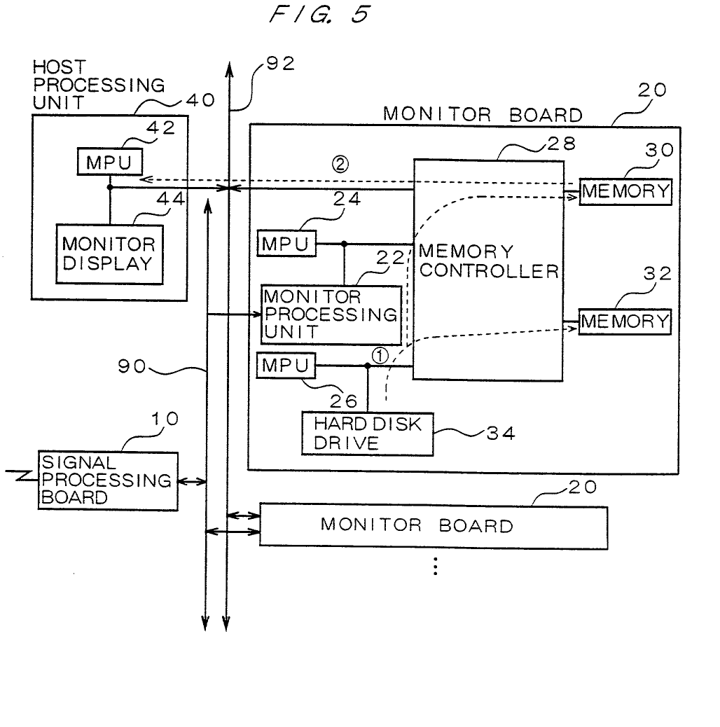

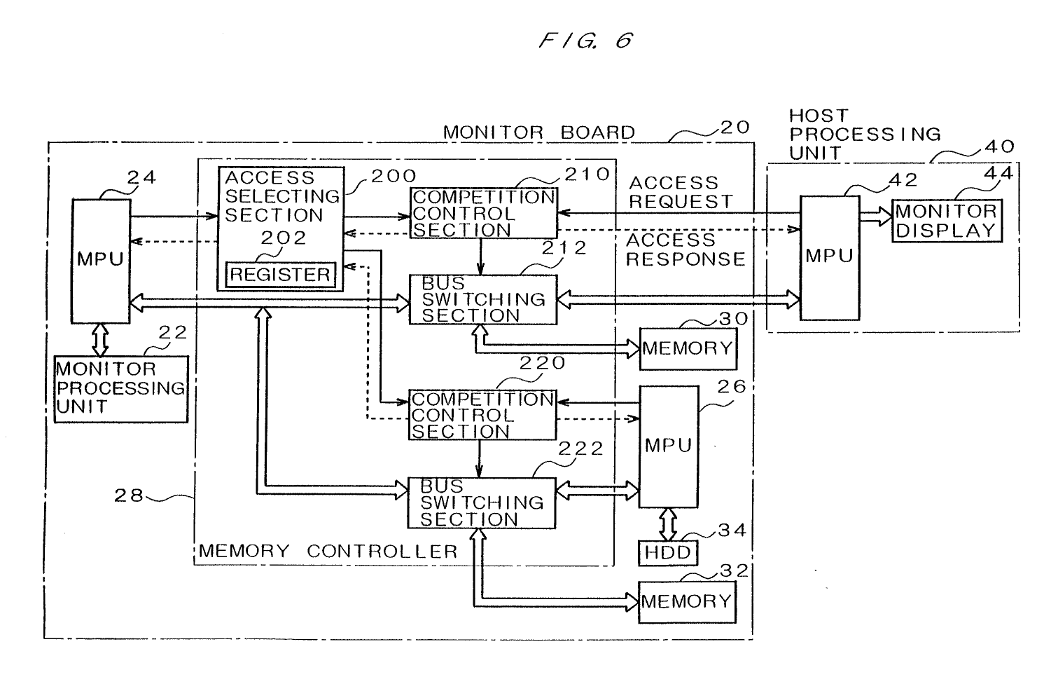

FIG. 6 is a diagram showing the detailed structure of the memory controller 28. The memory controller 28 shown in FIG. 6 is constituted by including an access selecting section 200, competition control sections 210 and 220, and bus switching sections 212 and 222.

The access selecting section 200 provides access permission of the memories 30 and 32 for the MPU 24 and the detail of the access permission is set by writing “1” in a predetermined bit of an internal register 202.

The competition control section 210 performs the control for giving priority to either of a request for access to the memory 30 from the MPU 24 and a request for access to the memory 30 from the MPU 42 when the above requests compete with each other. For example, the section 210 performs the control for alternately giving priority to the access request from the MPU 24 and the access request from the MPU 42. Similarly, the competition control section 220 performs the control for giving priority to either of a request for access to the memory 32 from the MPU 24 and a request for access to the memory 32 from the MPU 26 when the requests compete with each other.

The bus switching section 212 switches connection destination to which the memory 30 is connected through a bus, which connects the MPU 24 or 42 with the memory 30 in accordance with the control by the competition control section 210. Similarly, the bus switching section 222 switches connection destinations to which the memory 32 is connected through a bus, which connects the MPU 24 or 26 with the memory 32 in accordance with the control by the competition control section 220.

FIG. 7 is a diagram showing the relation between the content of a register 202 in the access selecting section 200 and various access permissions for the memories 30 and 32. The register 202 stores the access information for designating the permission for reading or writing data from or in the memories 30 and 32 from the MPU 24. Before data is read or written from or in the memories 30 and 32 from the MPU 24, a bit concerned is set to “1” or “0” by the MPU 24.

For example, the memories 30 and 32 respectively have a “data region” used to transfer the data mainly acquired by the monitor processing unit 22 and a “communication region” used to transfer the data for mainly controlling the MPU 24 and other MPUs 26 and 42 and access permission is separately set to each region. Moreover, the memory 30 and the memory 32 have the same structure in which the same address is assigned to each region.

The read permission (RE1) for the data region of the memory 30 is set to the zero-th bit (least significant bit) D0 of the 8-bit register 202. The value “1” is set to the bit D0 when permitting the read operation and “0” is set to the bit D0 when not permitting the read operation. Moreover, the write permission (WE1) for the data region of the memory 30 is set to the first bit D1 of the register 202. When permitting the write operation, “1” is set to the bit D1 but “0” is set to the bit D1 when not permitting the write operation.

Similarly, the read permission (RE2) for the data region of the memory 32 is set to the second bit D2 of the register 202 and the write permission (WE2) for the data region of the memory 32 is set to the third bit D3 of the register 202.

Moreover, the read permission (RE3) for the communication region of the memory 30 is set to the fourth bit D4 of the register 202 and the write permission (WE3) for the communication region of the memory 30 is set to the fifth bit D5 of the register 202. The read permission (RE4) for the communication region of the memory 32 is set to the sixth bit D6 of the register 202 and the write permission (WE4) for the communication region of the memory 32 is set to the seventh bit D7 of the register 202.

The memory controller 28 has the above detailed structure and operations of the controller 28 are described below.

1) Simultaneous write operation of data

First, the operation is described when the simultaneous write mode for simultaneously writing data in the data regions of the memories 30 and 32 is designated in accordance with one-time write designation. For example, the above operation corresponds to the operation of acquiring data by the monitor processing unit 22, storing the acquired data in the memory 32 in order to keep the data in the hard disk drive (HDD) 34, and storing the data in the memory 30 in order to make the data ready for read by the MPU 42 in the host processing unit 40.

Before writing the data, the MPU 24 sets the first bit D1 and the third bit D3 of the register 202 in the access selecting section 200 to “1” and thereby, designates the simultaneous write mode for the memory controller 28.

To write data in the memories 30 and 32 from the MPU 24 after designating the simultaneous write mode as described above, the MPU 24 first sends a data write address and an access request corresponding to data write to the access selecting section 200. The access selecting section 200 recognizes that regions to be accessed are the data regions of the memories 30 and 32 in accordance with the write address sent from the MPU 24 and thereafter, decides whether the write permission for these data regions is made by checking the first bit D1 and the third bit D3 of the register 202. When the simultaneous write mode is designated, the write permission is made because these bits D1 and D3 are set to “1.” Then, the access selecting section 200 sends an access request to the competition control section 210 corresponding to the memory 30 and the competition control section 220 corresponding to the memory 32.

The competition control section 210 sends a designation to the bus switching section 212 to connect the memory 30 to the MPU 24 immediately when access requests sent from the MPU 42 do not compete with each other but after the access to the memory 30 is enabled when the requests compete with each other and sends an access response to the access selecting section 200. Similarly, the competition control section 220 sends a designation to the bus switching section 222 to connect the memory 32 to the MPU 24 immediately when access requests sent from the MPU 26 do not compete with each other but after the access to the memory 32 is enabled when the requests compete with each other and returns an access response to the access selecting section 200. When access responses are returned from the competition control sections 210 and 220, the access selecting section 200 sends an access response to the MPU 24.

When receiving the access response from the access selecting section 200, the MPU 24 sends a write address and acquired data (write data) to the memory 30 through the bus switching section 212 and also sends the address and the data to the memory 32 through the bus switching section 222. Thus, the same acquired data is written in the same addresses of the memories 30 and 32.

Thus, by setting the first bit D1 and third bit D3 of the register 202 in the access selecting section 200 to “1” and effectuating the write permission for the data regions of the memories 30 and 32, it is possible to write the same data in the same addresses of the memories 30 and 32 through one-time write operation. Therefore, it is possible to decrease the time required for data write. Moreover, because the MPU 24 designates one write address for the memories 30 and 32, it is easy to control addresses compared to the case of designating write addresses different from each other to each of the memories 30 and 32 and thus, it is possible to reduce the load of processing.

For the above example, a case is described in which the MPU 24 sends a write address and acquired data to the memory controller 28. The same is true for the case in which the monitor processing unit 22 serves as a bus master to send a write address and acquired data to the memory controller 28. In this case, the MPU 24 sets the register 202 in the access selecting section 200 and directly inputs or outputs an access request, access response, write address, and acquired data between the monitor processing unit 22 and the memory controller 28.

2) Transfer operation of data

Then, the operation of reading data from the data region of the memory 32 and transferring the data to the data region of the memory 30 is described below. For example, the above operation corresponds to the operation when the data is read from the hard disk drive 34 by the MPU 26 and stored in the memory 32 and thereafter, the MPU 42 in the host processing unit 40 transfers the read data to the accessible memory 30.

Before transferring the data, the MPU 24 sets the zero-th bit D0 of the register 202 in the access selecting section 200 to “0,” the first bit D1 to “1,” the second bit D2 to “1,” and the third bit D3 to “0.”

Thus, after setting the contents of the register 202 of the access selecting section 200, the MPU 24 sends a data read address and an access request corresponding to data read to the access selecting section 200. The access selecting section 200 recognizes that the regions to be accessed are the data regions of the memories 30 and 32 in accordance with the read address sent from the MPU 24 and thereafter, decides whether the read permission is made for these data regions by checking the zero-th bit D0 and the second bit D2 of the register 202. In this case, because the zero-th bit D0 is set to “0” and the second bit D2 is set to “1,” the read permission is made for the memory 32. Therefore, the access selecting section 200 then sends an access request to the competition control section 220 corresponding to the memory 32.

The competition control section 220 sends a designation to the bus switching section 222 to connect the memory 32 to the MPU 24 immediately when access requests sent from the MPU 26 do not compete with each other but after the access to the memory 32 is enabled when the requests compete with each other and thereafter, returns an access response to the access selecting section 200. When the access response is returned from the competition control section 220, the access selecting section 200 sends the access response to the MPU 24.

When receiving the access response from the access selecting section 200, the MPU 24 sends a read address to the memory 32 through the bus switching section 222 and thus, the stored data is read from a data region designated by the read address.

Then, the MPU 24 sends a data write address and an access request corresponding to data write to the access selecting section 200. The read address designated when previously reading data is directly used as the data write address. The access selecting section 200 recognizes that regions to be accessed are the data regions of the memories 30 and 32 in accordance with the write address sent from the MPU 24 and thereafter, decides whether the write designation for these data regions is permitted by checking the first bit D1 and the third bit D3 of the register 202. In this case, because the first bit D1 is set to “1” and the third bit D3 is set to “0,” the write permission is made only for the memory 30. Therefore, the access selecting section 200 then sends an access request to the competition control section 210 corresponding to the memory 30.

The competition control section 210 sends a designation to the bus switching section 212 to connect the memory 30 to the MPU 24 immediately when access requests sent from the MPU 42 do not compete with each other but after the access to the memory 30 is enabled when the requests compete with each other and thereafter, returns an access response to the access selecting section 200. When the access response is returned from the competition control section 210, the access selecting section 200 sends the access response to the MPU 24.

When receiving the access response from the access selecting section 200, the MPU 24 sends a write address and the data previously read out of the memory 32 to the memory 30 through the bus switching section 212 and thus, the data is written in the data region of the memory 30 designated by the write address.

Thus, when transferring data to the memory 30 from the memory 32, the MPU 24 designates an address to read data and thereafter, only writes the data in the same address. Therefore, after setting the register 202, it is unnecessary to designate that a data read destination is the memory 32 and a data write destination is the memory 30. Therefore, it is possible to simplify the processing procedure of data transfer operation.

Moreover, in the case of the above example, data is read out of the memory 32 and the read data is written in the same address of the memory 30. However, when sending a result analyzed by the host processing unit 40 to the MPU 26, it is also possible to consider a case of writing the data read out of the memory 30 in the memory 32. In this case, it is necessary to set the zero-th bit D0 of the register 202 in the access selecting section 200 to “1,” the first bit D1 to “0,” second bit D2 to “0”, and third bit D3 to “1.” Moreover, to write data in an address different from the address from which data is read, it is necessary to designate a write address different from a read address.

3) Other operations

The memories 30 and 32 are respectively provided with a communication region in addition to a data region. Therefore, it is possible to designate various access states to the communication region similarly to the data region but with the content different from that of the data region. Therefore, by setting the data regions of the memories 30 and 32 for simultaneous data write and the communication regions of the memories 30 and 32 for data transfer, it is possible to perform the operation for writing the data acquired by the monitor processing unit 22 in the memories 30 and 32 at the same time and the operation for transferring data or designations between the MPU 26 and the MPU 42 in parallel.

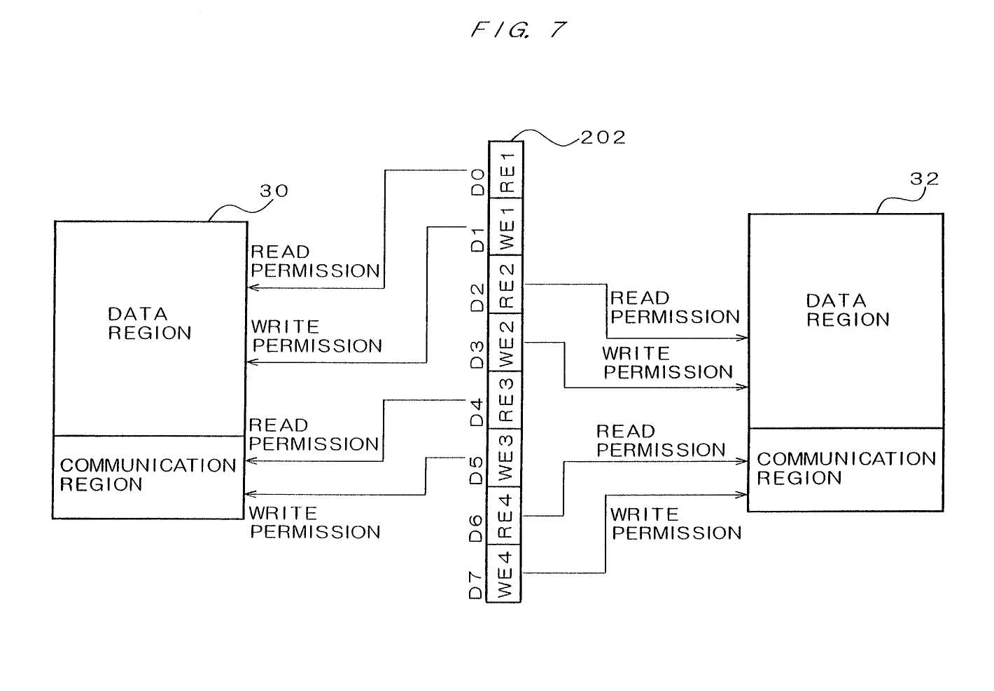

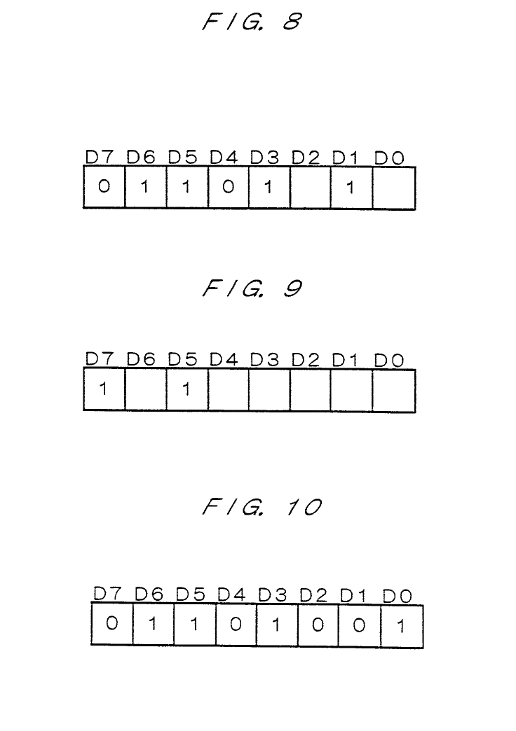

FIG. 8 is a diagram showing the contents set in the register 202 when performing the operation for writing data in the memories 30 and 32 at the same time and the operation for transferring data from the MPU 26 to the MPU 42 in parallel. As described above, by setting the first bit D1 and the third bit D3 of the register 202 to “1,” it is possible to write data in the memories 30 and 32 respectively using a data region at the same time. Moreover, by setting the fourth bit D4 of the register 202 to “0,” the fifth bit D5 to “1,” the sixth bit D6 to “1,” and the seventh bit D7 to “0,” it is possible to transfer data from the memory 32 accessible by the MPU 26 to the memory 30 accessible by the MPU 42 by using a communication region.

Thus, by providing a communication region separate from a data region to the memories 30 and 32 respectively and separately setting each access state to them, it is possible to perform the operation for simultaneously writing data and the operation for transferring data between the MPU 26 and the MPU 42 in parallel.

Moreover, it is possible to use the data regions and communication regions of the memories 30 and 32 in the completely same operation mode depending on the content set in the register 202. For example, as shown in FIG. 9, by setting the fifth bit D5 and the seventh bit D7 of the register 202 to “1,” it is possible to write the data acquired by the monitor processing unit 22 in the memories 30 and 32 at the same time by using the communication regions. Moreover, as shown in FIG. 10, by setting the zero-th bit D0, third bit D3, fifth bit D5, and sixth bit D6 of the register 202 to “1” and the first bit D1, second bit D2, fourth bit D4, and seventh bit D7 to “0,” it is possible to send data from the MPU 26 to the MPU 42 by using the communication regions and send data from the MPU 42 to the MPU 26 by using the data regions.

Thus, by using the memory controller 28 whose detailed structure is shown in FIG. 6, it is possible to simultaneously write data in the same addresses of the memories 30 and 32 from the MPU 24 through one-time write operation. Moreover, in the case of the data transfer operation for writing the data read out of one of the memories 30 and 32 in the other, the MPU 24 only has to perform the operation for writing the data read out of an address in its address space in the same address. Particularly, because the regions of the memories 30 and 32 correspond to the same address, it is possible to effectively use the address space of the MPU 24 compared to the case of making a different address correspond to each region of the memories 30 and 32. Therefore, when the number of address buses of the MPU 24 is small or the address space usable for a data region or communication region is limited, it can be said that the technique of this embodiment for making the same address correspond to each region of the memories 30 and 32 and setting the access state of each region in accordance with the content of the register 202 is particularly effective.

Incidentally, the present invention is not limited to the above-mentioned embodiment, and various modified embodiments may be attained within the scope of the gist of the present invention. For example, with respect to the long-time recording/reproduction operation referring to FIG. 5, in the data acquisition apparatus according to the embodiment of the present invention, the acquired data read out from the hard disk drive 34 are saved in one memory 32 and then transferred to the other memory 30. However, the MPU 24 not only transfers the data but also may perform in conjunction with some other data processes such as a data retrieving and selection at the data transfer operation. Further, in the above-described embodiment, although the host processing unit 40 performs the display operation of the acquired data, concurrently with such a display operation or replacing the display operation, some other software processings may be performed.

Moreover, the data acquisition apparatus of the above embodiment is constituted so as to have one monitor processing unit 22 in a monitor board. However, it is also possible for the apparatus to have a plurality of monitor processing units 22. In this case, it is preferable to use the memories 30 and 32 by dividing the insides of them in accordance with the number of monitor processing units 22 or use the memories 30 and 32 and the hard disk drive 34 by dividing the insides of them in accordance with the number of monitor processing units 22.

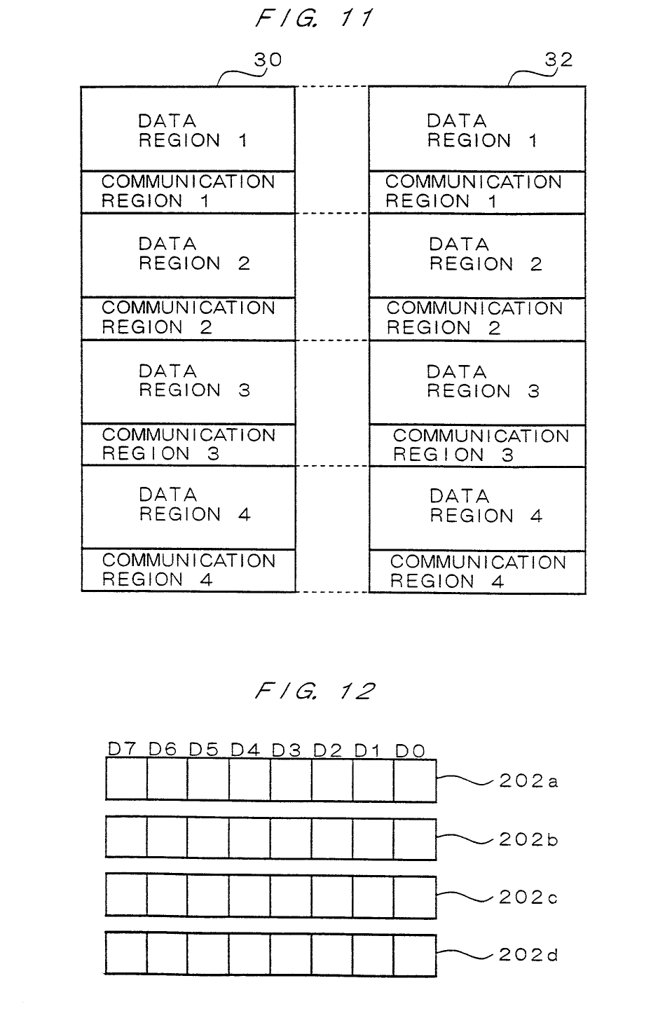

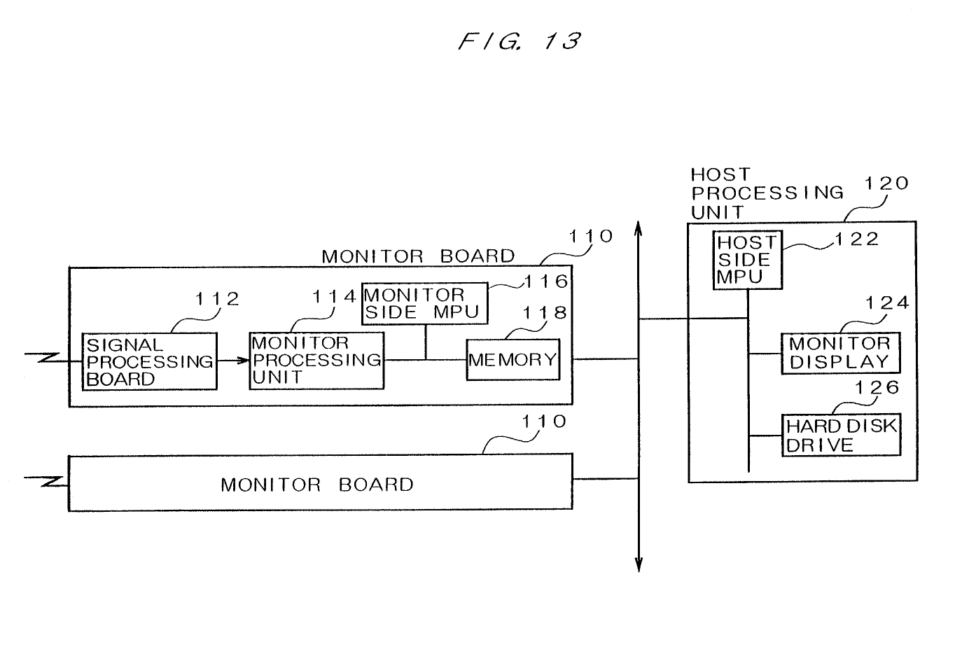

FIG. 11 shows a case in which four monitor processing units 22 are set in the monitor board 20, which is a diagram showing storage regions when respectively dividing the insides of the memories 30 and 32 into four regions in accordance with the number of monitor processing units 22. As shown in FIG. 11, the memory 30 is provided with four data regions 1 to 4 and four communication regions 1 to 4. A set of data and communication regions corresponds to each of the four monitor processing units 22 and the data acquired by each monitor processing unit 22 is stored in the data region corresponding to each monitor processing unit 22. Moreover, the region of the memory 32 is divided similarly to the case of the memory 30 and the same address is provided for each corresponding data region and communication region. Thus, when using the memories 30 and 32 by respectively dividing them into four regions so as to correspond to each of four monitor processing units 22, four registers 202a, 202b, 202c, and 202d are set in the access selecting section 200 in order to set the access content of each divided region as shown in FIG. 12. The content of each of the registers 202a to 202d is the same as that of the register 202 shown in FIG. 7 and it is possible to set a different access content to the storage region and communication region of each divided region.

1. A data acquisition apparatus comprising:
a data acquisition processing unit for acquiring certain data sent and/or received via lines; and
a data display processing unit for displaying the data acquired by said data acquisition processing unit,
wherein said data acquisition processing unit transfers the data to a storing means for sequentially storing the acquired data.

2. A data acquisition apparatus according to claim 1, wherein said storing means is a hard disk drive.

3. A data acquisition apparatus according to claim 1, wherein said data acquisition processing unit is a monitor board for extracting the certain data to be a candidate for acquisition among the data received by a signal processing board connected to said lines and for performing the acquisition operation of the data.

4. A data acquisition apparatus according to claim 1, wherein said data acquisition processing unit comprises:
a data extracting means for extracting the certain data sent and/or received via said lines;
a first memory used for transferring the data to said data display processing unit, for storing the data extracted by said data extracting means; and
a second memory used for transferring the data to said storing means, for storing the data extracted by said data extracting means.

5. A data acquisition apparatus according to claim 4, wherein said data extracting means is a monitor processing unit for extracting only the data that meets with the acquisition requirement among the multiplexed data outputted from said data acquisition processing unit.

6. A data acquisition apparatus according to claim 3, wherein said data acquisition processing unit comprises:
a first processor for instructing to write the data extracted by said data extracting means into said first and second memories;
a memory controller for writing the data into said first and second memories according to a single write instruction made by said first processor; and
a second processor for storing the data read out from said second memory to said storing means.

7. The data acquisition apparatus according to claim 6, wherein
a common address is provided for each storage region of said first and second memories, and
when one write address is designated by said first processor, said memory controller writes data in said storage region of each of said first and second memories specified by said write address.

8. The data acquisition apparatus according to claim 4, wherein said data acquisition processing unit comprising:
a first processor for designating read or write of data for said first and second memories, and
a memory controller for reading data from one of said first and second memories when read of the data is designated by said first processor or writing data in the other of them when write of the data is designated by said first processor.

9. The data acquisition apparatus according to claim 8, wherein
a common address is provided for each storage region of said first and second memories, and
said first processor designates read or write of data from or in the same address for said memory controller.

10. A data acquisition apparatus according to claim 1, said data acquisition processing unit is plural and includes said storing means, individually.

11. A memory controller connecting with first and second memories and a first processor for reading or writing data from or in these two memories, comprising:
an access selecting section for selecting said first and second memories from or in which data is read or written when a data read/write request is given from said first processor in accordance with the access information for the data read/write permission previously set correspondingly to each of said first and second memories.

12. The memory controller according to claim 11, further comprising:
a first bus switching section for connecting said first processor with said first memory and a second bus switching section for connecting said first processor with said second memory in accordance with a selection result by said access selecting section.

13. The memory controller according to claim 12, wherein a common address is provided for each storage region of said first and second memories, and
when write of data in said first and second memories is permitted in accordance with said access information, said first processor is connected with said first and second memories by said first and second bus switching sections correspondingly to one-time write designation sent from said first processor to write data in said first and second memories.

14. The memory controller according to claim 12, wherein
a common address is provided for each storage region of said first and second memories,
when read of data from one of said first and second memories and write of data in the other of them are permitted in accordance with said access information, said first processor is connected with one of said first and second memories by one of said first and second bus switching sections correspondingly to a data read designation sent from said first processor to read data and said first processor is connected with the other of said first and second memories by the other of said first and second bus switching sections correspondingly to a data write designation sent from said first processor to write data.

15. The memory controller according to claim 11, wherein
said first and second memories respectively have a plurality of divided storage regions and said access information is set to each divided storage region.
